(19) United States
(12) Patent Application Publication
(10) Pub. No.: US 2004/0112155 A1
(43) Pub. Date: Jun. 17, 2004

(54) Arrangement for balancing of rotating bodies

(76) Inventor: Goran Uhlin, Lagan (SE)

Correspondence Address: PEARNE & GORDON LLP, 1801 EAST 9TH STREET, SUITE 1200, CLEVELAND, OH, 44114-3108, US

(21) Appl. No.: 10/467,117

(22) PCT Filed: Jan. 31, 2002
(86) PCT No.: PCT/SE02/00181

(30) Foreign Application Priority Data
Feb. 6, 2001 (SE) 01003771

(51) Int. Cl. F16H 21/12

(52) U.S. Cl. 74/63

(57) ABSTRACT

An arrangement for balancing of rotating bodies, such as containers (10) for wash loads in washing machines and spindriers, comprises at least one annular closed path (20,22) rotating with the container (10) and in which at least two spherical balancing bodies (24) are movably disposed. The annular path (20,22) is composed of at least two parts (26,28) together forming a race for the spherical balancing bodies (24). In the area of the race the two parts (26,28) have two portions (34,36) which are facing one another and are convexly curved and have a shape so as to form on the respective part of a race track (30,32) along lines disposed so as to guide the balancing body (24) towards a symmetry line (38) of the annular path (20,22) during rotation.

The present invention refers to an arrangement for balancing of rotating bodies, such as containers for laundry in washing machines and spin-driers.

An arrangement of the kind referred to is known from the patent publication U.S. Pat. No. 2,984,094. The publication shows a laundry washing machine provided with a drum supporting the laundry. At both gables of the drum annular closed paths are provided in which balancing bodies are movably disposed. In FIG. 13 of the publication, in particular, a top load machine is shown in which the balancing bodies are balls which run on an annular race in the form of a steel band pressed into the annular closed path. In this way a race is obtained that will nearly stand up to any amount of wear. The annular closed paths are formed by the respective gable of the drum and a cover secured thereto.

Also the patent publication WO 97/16657 discloses a balancing arrangement of the kind referred to wherein a race for rotating balancing balls are formed by an inlay of steel, here in the form of a steel wire of a special shape.

In the balancing arrangements described above the race for the rotating balancing weights has been formed by an inlay of a band or wire of steel for the purpose of obtaining a low amount of wear and deformation during the operation of the machine and, accordingly, operating characteristics that remain the same for a long time. At the same time, the extra inlay involves a more complex structure of the annular path than if the inlay had been dispensed with.

The object of the invention is to eliminate the drawback indicated above and provide a balancing arrangement of the kind indicated in which a long life of the race is obtained at the same time as the control of the balls during rotation is improved and as a result the tendency of the balls to wobble during rotation is reduced. In turn, this causes the friction losses to be reduced and also the level of noise from the balancing arrangement to be lowered.

The object is achieved in a balancing arrangement having the characterizing features indicated in claim 1. Preferred embodiments are included in the associated sub-claims.

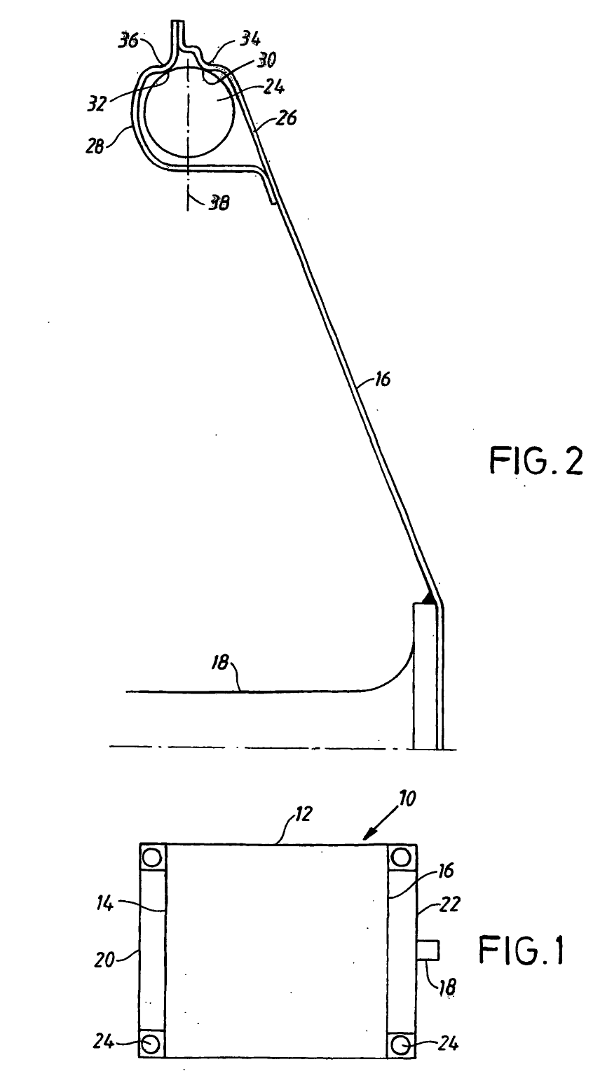

The invention will now be described more in detail in connection with an embodiment with reference to an accompanying drawing, in which FIG. 1 schematically shows a wash drum provided with a balancing arrangement, and FIG. 2 shows a detail view of a balancing arrangement which can be mounted on the wash drum according to FIG. 1.

With reference to FIG. 1 there is schematically shown a wash drum 10 provided to support a wash load during washing and drying processes which take place in a washing machine in which the wash drum is included. In a usual way the wash drum 10 has a cylindrical envelope surface 12 to which are connected two gables 14, 16. In this embodiment the washing machine is constructed to be loaded via the gable 14. In a way commonly known, the opposite gable 16 is connected to a driving shaft 18. In a way not described in detail, the driving shaft is journalled in a bearing housing which forms an assembly with a tub in the form of an outer drum, not shown, containing the wash drum 10. The wash drum 10 is provided with a balancing arrangement comprising annular paths 20, 22 secured to the gables 14, 16 and containing balancing bodies 24 which can move freely. The annular paths 20, 22 rotate with the wash drum 10 and during rotation the balancing bodies can move in the respective path 20, 22 thereby taking positions in order to compensate, in each moment during a spin-drying phase, for the imbalance caused by the unevenly distributed wash load in the wash drum 10.

With reference to FIG. 2, according to the invention the annular paths 20, 22 are formed by two parts 26, 28 of which part 26 is formed by the adjacent gable 14 and 16, respectively, and part 28 is formed by a cover secured to the gable 14, 16. For the creation of races for the balancing bodies, having the form of balls, preferably made of steel, the respective part 26, 28 has curved portions 34, 36 bearing on the ball-shaped balancing bodies 24 along curved lines forming race tracks 30, 32 and being symmetrically disposed with respect to a symmetry line 38 of the annular path. The race tracks 30, 32 are disposed at such a distance from the symmetry line 38 that the ball-shaped balancing bodies 24 are guided towards the symmetry line so that the tendency of the bodies 24 to wobble is reduced or does not even occur. In order to give the race tracks 30, 32 a great durability against wear, during the manufacture of the gables 14, 16 and the cover-forming part 28, the curving of the parts 34, 66 can be carried out in a process including a stamping step giving an increased surface hardness in the area of the race tracks 30, 32. During the forming of the two parts of the path in the stamping step the material of said parts is brought into creeping in the area of the race tracks 30, 32.

In the manufacture of a wash drum with gables and balancing arrangement, first the forming of the gables 14, 16 and the cover parts 28 takes place and then the ball-shaped balancing bodies 24 are inserted together with a liquid of a suitable viscosity into the annular cover part 28 which is thereafter joined to the respective gable 14, and 16, respectively, by means of any suitable method, such as riveting, gluing, or welding. The object of the liquid is to damp the movement of the ball-shaped balancing bodies and to reduce the noise that can occur when the bodies rotate and when they hit one another. In addition, the liquid shall facilitate the conveying of the bodies, for example at start after the wash drum has been standing still. In addition to having a suitable viscosity the liquid is also required to have a suitable quality, i.e. the viscosity and the density of the liquid shall be as stable as possible within the actual temperature range.

Accordingly, by the invention a balancing arrangement has been provided which has a simple design where the durability of the race tracks is maintained without any particular inlays of steel, specially treated. Moreover, it is achieved an improved guiding of the ball-shaped balancing bodies during their rotation in the annular paths and at the same time a reduced tendency of wobbling with associated friction losses.

1. Arrangement for balancing of rotating bodies, such as containers (10) for wash loads in washing machines and spin-driers, comprising at least one annular closed path (20, 22) rotating with the container (10) and in which at least two spherical balancing bodies (24) are movably disposed, characterized in that the annular path (20, 22) is composed of at least two parts (26, 28) together forming a race for the spherical balancing bodies (24), and in the area of the race the two parts (26, 28) have two portions (34, 36) which are facing one another and are convexly curved and have a shape so as to form on the respective part a race track (30, 32) along lines disposed so as to guide the balancing body (24) towards a symmetry line (38) of the annular path (20, 22) during rotation.

2. Arrangement according to claim 1, characterized in that curving of the two parts (26, 28) of the path is accomplished by a process including a stamping step giving an increased surface hardness in the area of the race tracks (30, 32).

3. Arrangement according to claim 2, characterized in that during forming of the two parts (26, 28) of the path the material in the area of the race tracks (30, 32) are brought into creeping.
